(19) United States
(12) Patent Application Publication
(10) Pub. No.: US 2025/0391356 A1
(43) Pub. Date: Dec. 25, 2025

(54) PIXEL CIRCUIT, DISPLAY DEVICE INCLUDING THE PIXEL CIRCUIT, AND ELECTRONIC DEVICE INCLUDING THE DISPLAY DEVICE

(71) Applicant: Samsung Display Co., LTD., Yongin-si (KR)

(72) Inventors: JIYOUNG LEE, Yongin-si (KR); HYUNYOUNG CHOI, Yongin-si (KR); SANG-GU LEE, Yongin-si (KR); HYUNG UK CHO, Yongin-si (KR); Jisong Chae, Yongin-si (KR)

(21) Appl. No.: 19/074,187

(22) Filed: Mar. 7, 2025

(30) Foreign Application Priority Data
Jun. 21, 2024 (KR) 10-2024-0080974

(51) Int. Cl. G09G 3/3233

(52) U.S. Cl. CPC G09G 3/3233; G09G 2300/0465; G09G 2300/0819; G09G 2300/0852; G09G 2300/0861; G09G 2310/08; G09G 2330/021

(57) ABSTRACT

A pixel circuit includes a first capacitor and a second capacitor, and a data voltage applied to the pixel circuit is distributed by a voltage distribution of the first capacitor and the second capacitor.

The present application claims priority to and the benefit of Korean Patent Application No. 10-2024-0080974, filed on Jun. 21, 2024, in the Korean Intellectual Property Office, the entire disclosure of which is incorporated herein by reference.

### BACKGROUND

### 1. Field

Aspects of some embodiments of the present disclosure relate to a pixel circuit, a display device including the pixel circuit, and an electronic device including the display device.

### 2. Description of the Related Art

In general, a display device includes a display panel and a display panel driver. The display panel includes gate lines, data lines, emission lines, and pixel circuits. The display panel driver includes a gate driver for providing a gate signal to the gate lines, a data driver for providing a data voltage to the data lines, an emission driver for providing an emission signal to the emission lines, and a driving controller for controlling the gate driver, the data driver, and the emission driver.

Recently, a display device having a relatively small area and high PPI (Pixels Per Inch) may be desirable to consumers. In this case, because a pitch occupied by the pixel circuit may be narrowed, there may be restrictions on a number of transistors constituting the pixel circuit and a signal applied to the pixel circuit.

The above information disclosed in this Background section is only for enhancement of understanding of the background and therefore the information discussed in this Background section does not necessarily constitute prior art.

### SUMMARY

Aspects of some embodiments of the present disclosure include a pixel circuit for a small area and high PPI.

Aspects of some embodiments of the present disclosure include a display device including the pixel circuit.

Aspects of some embodiments of the present disclosure include an electronic device including the display device.

In a pixel circuit according to some embodiments of the present disclosure, the pixel circuit includes a first transistor including a control electrode connected to a first node, a first electrode connected to a line of a high power supply voltage, and a second electrode connected to a second node, a second transistor including a control electrode receiving a data write gate signal, a first electrode connected to a data line providing a data voltage, and a second electrode connected to the second node, a third transistor including a control electrode receiving a reset gate signal of a next stage, a first electrode connected to the first node, and a second electrode connected to a third node, a first capacitor including a first electrode connected to the second node and a first electrode connected to the first node, a second capacitor including a first electrode connected to the third node and a second electrode connected to a fourth node, and a light emitting element including an anode connected to the fourth node and a cathode connected to a line of a low power supply voltage.

According to some embodiments, the pixel circuit may further comprise a fourth transistor including a control electrode receiving an initialization gate signal, a first electrode connected to the line of the low power supply voltage, and a second electrode connected to the fourth node.

According to some embodiments, the pixel circuit may further comprise a fifth transistor selectively connecting the line of the high power supply voltage and the first electrode of the first transistor in response to a first emission signal.

According to some embodiments, the pixel circuit further comprise a fifth transistor selectively connecting the second electrode of the first transistor and the second node in response to a first emission signal.

According to some embodiments, the pixel circuit further comprise a sixth transistor selectively connecting the second node and the fourth node in response to a second emission signal, and a seventh transistor selectively connecting the fourth node and the anode of the light emitting element in response to a third emission signal.

According to some embodiments, the pixel circuit further comprise an eighth transistor including a control electrode receiving a reset gate signal, a first electrode connected to a line of a reference voltage, and a second electrode connected to the first node.

According to some embodiments, the first to eighth transistors may be N-type transistors.

According to some embodiments, in a first duration, the reset gate signal, the initialization gate signal, the second emission signal, and the third emission signal may have a high level, the data write gate signal, the reset gate signal of the next stage, and the first emission signal may have a low level, the fourth transistor may be turned on in response to the initialization gate signal having the high level to provide the low power supply voltage to the fourth node, the sixth transistor may be turned on in response to the second emission signal having the high level to provide a voltage of the fourth node to the second node, and the eighth transistor may be turned on in response to the reset gate signal having the high level to provide the reference voltage to the first node.

According to some embodiments, in a second duration following the first duration, the reset gate signal, the reset gate signal of the next stage, the initialization gate signal, the second emission signal, and the third emission signal may have the high level, the data write gate signal and the first emission signal may have the low level, the fourth transistor may be turned on in response to the initialization gate signal having the high level to provide the low power supply voltage to the fourth node, the sixth transistor may be turned on in response to the second emission signal having the high level to provide the voltage of the fourth node to the second node, the seventh transistor may be turned on in response to the third emission signal having the high level to provide the voltage of the fourth node to the anode of the light emitting element, the eighth transistor may be turned on in response to the reset gate signal having the high level to provide the reference voltage to the first node, and the third transistor may be turned on in response to the reset gate signal of the next stage having the high level to provide a voltage of the first node to the third node.

According to some embodiments, in a third duration following the second duration, the reset gate signal, the reset gate signal of the next stage, the initialization gate signal, and the second emission signal may have the high level, the data write gate signal, the first emission signal, and the third emission signal may have the low level, the fourth transistor may be turned on in response to the initialization gate signal having the high level to provide the low power supply voltage to the fourth node, the sixth transistor may be turned on in response to the second emission signal having the high level to provide the voltage of the fourth node to the second node, the eighth transistor may be turned on in response to the reset gate signal having the high level to provide the reference voltage to the first node, and the third transistor may be turned on in response to the reset gate signal of the next stage having the high level to provide the voltage of the first node to the third node.

According to some embodiments, in a fourth duration following the third duration, the reset gate signal, the reset gate signal of the next stage, the first emission signal, and the second emission signal may have the high level, the data write gate signal, the initialization gate signal, and the third emission signal may have the low level, the eighth transistor may be turned on in response to the reset gate signal having the high level to provide the reference voltage to the first node, the third transistor may be turned on in response to the reset gate signal of the next stage having the high level to provide the voltage of the first node to the third node, the fifth transistor may be turned on in response to the first emission signal having the high level to provide the high power supply voltage to the first electrode of the first transistor, and the sixth transistor may be turned on in response to the second emission signal having the high level to provide a voltage of the second node to the fourth node.

According to some embodiments, in a fifth duration following the fourth duration, the reset gate signal, the reset gate signal of the next stage, and the second emission signal may have the high level, the data write gate signal, the initialization gate signal, the first emission signal, and the third emission signal may have the low level, the eighth transistor may be turned on in response to the reset gate signal having the high level to provide the reference voltage to the first node, the third transistor may be turned on in response to the reset gate signal of the next stage having the high level to provide the voltage of the first node to the third node, and the sixth transistor may be turned on in response to the second emission signal having the high level to connect the second node and the fourth node.

According to some embodiments, in a sixth duration following the fifth duration, the reset gate signal of the next stage may have the high level, and the data write gate signal, the reset gate signal, the initialization gate signal, the first emission signal, the second emission signal, and the third emission signal may have the low level.

According to some embodiments, in a seventh duration following the sixth duration, the data write gate signal, the reset gate signal of the next stage, and the initialization gate signal may have the high level, the reset gate signal, the first emission signal, the second emission signal, and the third emission signal may have the low level, the fourth transistor may be turned on in response to the initialization gate signal having the high level to provide the low power supply voltage to the fourth node, the second transistor may be turned on in response to the data write gate signal having the high level to provide the data voltage to the second node, and the third transistor may be turned on in response to the reset gate signal having the high level to connect the first node and the third node.

According to some embodiments, in an eighth duration following the seventh duration, the initialization gate signal may have the high level, the data write gate signal, the reset gate signal, the reset gate signal of the next stage, the first emission signal, the second emission signal, and the third emission signal may have the low level, and the fourth transistor may be turned on in response to the initialization gate signal having the high level to provide the low power supply voltage to the fourth node.

According to some embodiments, in a ninth duration following the eighth duration, the data write gate signal, the reset gate signal, the reset gate signal of the next stage, the initialization gate signal, the first emission signal, the second emission signal, and the third emission signal may have the low level.

According to some embodiments, in a tenth duration following the ninth duration, the first emission signal may have the high level, the data write gate signal, the reset gate signal, the reset gate signal of the next stage, the initialization gate signal, the second emission signal, and the third emission signal may have the low level, the fifth transistor may be turned on in response to the first emission signal having the high level to provide the high power supply voltage to the first electrode of the first transistor, and the first transistor may be turned on based on the data voltage to provide a voltage of the first electrode of the first transistor to the second node.

In a display device according to some embodiments of the present disclosure, the display device includes a display panel including a pixel circuit, and a display panel driver configured to drive the display panel. According to some embodiments, the pixel circuit comprises a first transistor including a control electrode connected to a first node, a first electrode connected to a line of a high power supply voltage, and a second electrode connected to a second node, a second transistor including a control electrode receiving a data write gate signal, a first electrode connected to a data line providing a data voltage, and a second electrode connected to the second node, a third transistor including a control electrode receiving a reset gate signal of a next stage, a first electrode connected to the first node, and a second electrode connected to a third node, a first capacitor including a first electrode connected to the second node and a first electrode connected to the first node, a second capacitor including a first electrode connected to the third node and a second electrode connected to a fourth node, and a light emitting element including an anode connected to the fourth node and a cathode connected to a line of a low power supply voltage.

In an electronic device according to some embodiments of the present disclosure, the electronic device comprises a display panel including a pixel circuit, a display panel driver configured to drive the display panel, and a processor configured to control the display panel driver. According to some embodiments, the pixel circuit comprises a first transistor including a control electrode connected to a first node, a first electrode connected to a line of a high power supply voltage, and a second electrode connected to a second node, a second transistor including a control electrode receiving a data write gate signal, a first electrode connected to a data line providing a data voltage, and a second electrode connected to the second node, a third transistor including a control electrode receiving a reset gate signal of a next stage, a first electrode connected to the first node, and a second electrode connected to a third node, a first capacitor including a first electrode connected to the second node and a first electrode connected to the first node, a second capacitor including a first electrode connected to the third node and a second electrode connected to a fourth node, and a light emitting element including an anode connected to the fourth node and a cathode connected to a line of a low power supply voltage.

According to some embodiments of the present disclosure, in the pixel circuit, the display device including the pixel circuit, and the electronic device including the pixel circuit, the pixel circuit may include a first capacitor and a second capacitor, and a data voltage applied to the pixel circuit may be distributed by a voltage distribution of the first capacitor and the second capacitor. Accordingly, a data range of the data voltage may be relatively expanded.

### BRIEF DESCRIPTION OF THE DRAWINGS

The above and other aspects of some embodiments of the present disclosure will become more apparent by describing in more detail aspects of some embodiments thereof with reference to the accompanying drawings, in which:

FIG. 1 is a block diagram showing a display device according to some embodiments of the present disclosure;

FIG. 2 is a circuit diagram showing an example of a pixel circuit of FIG. 1;

FIG. 3 is a timing diagram showing an example of an operation of a pixel circuit of FIG. 2;

FIG. 4 is a circuit diagram showing an example in which a pixel circuit of FIG. 2 operates in a first duration;

FIG. 5 is a circuit diagram showing an example in which a pixel circuit of FIG. 2 operates in a second duration;

FIG. 6 is a circuit diagram showing an example in which a pixel circuit of FIG. 2 operates in a third duration;

FIG. 7 is a circuit diagram showing an example in which a pixel circuit of FIG. 2 operates in a fourth duration;

FIG. 8 is a circuit diagram showing an example in which a pixel circuit of FIG. 2 operates in a fifth duration;

FIG. 9 is a circuit diagram showing an example in which a pixel circuit of FIG. 2 operates in a sixth duration;

FIG. 10 is a circuit diagram showing an example in which a pixel circuit of FIG. 2 operates in a seventh duration;

FIG. 11 is a circuit diagram showing an example in which a pixel circuit of FIG. 2 operates in an eighth duration;

FIG. 12 is a circuit diagram showing an example in which a pixel circuit of FIG. 2 operates in a ninth duration;

FIG. 13 is a circuit diagram showing an example in which a pixel circuit of FIG. 2 operates in a tenth duration;

FIG. 14 is a circuit diagram showing an example in which a pixel circuit of FIG. 2 operates in an eleventh duration;

FIG. 15 is a circuit diagram showing an example in which a pixel circuit of FIG. 2 operates in a twelfth duration;

FIG. 16 is a circuit diagram showing an example of a pixel circuit of FIG. 1;

FIG. 17 is a block diagram showing an electronic device; and

FIG. 18 is a diagram showing aspects of embodiments in which an electronic device of FIG. 17 is implemented as a smart phone.

### DETAILED DESCRIPTION

Hereinafter, aspects of some embodiments of the present disclosure will be described in more detail with reference to the accompanying drawings.

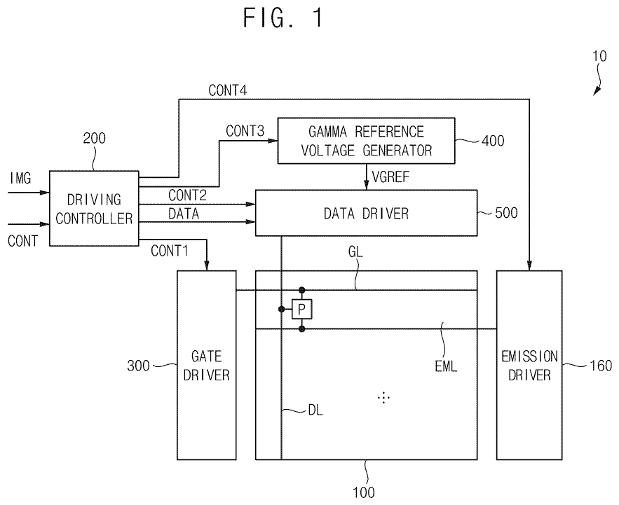

FIG. 1 is a block diagram showing a display device according to some embodiments of the present disclosure.

Referring to FIG. 1, a display device 10 may include a display panel 100 and a display panel driver. The display panel driver may include a driving controller 200, a gate driver 300, a gamma reference voltage generator 400, a data driver 500, and an emission driver 600.

According to some embodiments, the driving controller 200 and the data driver 500 may be formed integrally. According to some embodiments, the driving controller 200, the gamma reference voltage generator 400, and the data driver 500 may be formed integrally. According to some embodiments, the driving controller 200, the gate driver 300, the gamma reference voltage generator 400, and the data driver 500 may be formed integrally. According to some embodiments, the driving controller 200, the gate driver 300, the gamma reference voltage generator 400, the data driver 500, and the emission driver 600 may be formed integrally. According to some embodiments, a driving module in which at least the driving controller 200 and the data driver 500 are formed integrally may be named a timing controller embedded data driver (TED).

The display panel 100 may include a display area for displaying images and a peripheral area arranged adjacent to (e.g., in a periphery or outside a footprint of) the display area.

According to some embodiments, the display panel 100 may be an organic light emitting diode display panel including an organic light emitting diode. According to some embodiments, the display panel 100 may be a quantum-dot organic light emitting diode display panel including an organic light emitting diode and a quantum-dot color filter. According to some embodiments, the display panel 100 may be a quantum-dot nano light emitting diode display panel including a nano light emitting diode and a quantum-dot color filter. According to some embodiments, the display panel 100 may be a liquid crystal display panel including a liquid crystal layer.

The display panel 100 may include gate lines GL, data lines DL, emission lines EML, and pixel circuits P electrically connected to the gate lines GL, the data lines DL, and the emission lines EML, respectively. The gate lines GL may extend in a first direction, the data lines DL may extend in a second direction crossing the first direction, and the emission lines EML may extend in the first direction. Although FIG. 1 illustrates a single pixel P, a single gate line GL, a single data line DL, and a single emission line EML, embodiments according to the present disclosure are not limited thereto, and as a person having ordinary skill in the art would appreciate, the display panel 100 may have any suitable number of pixels P, gate lines GL, data lines DL, and emission lines EML according to the design and size of the display panel 100.

The driving controller 200 may receive input image data IMG and an input control signal CONT from an external device. According to some embodiments, the input image data IMG may include red image data, green image data and blue image data. The input image data IMG may include white image data. The input image data IMG may include magenta image data, yellow image data, and cyan image data. The input control signal CONT may include a master clock signal and a data enable signal. The input control signal CONT may further include a vertical synchronization signal and a horizontal synchronization signal.

The driving controller 200 may generate a first control signal CONT1, a second control signal CONT2, a third control signal CONT3, a fourth control signal CONT4, and a data signal DATA based on the input image data IMG and the input control signal CONT.

The driving controller 200 may generate the first control signal CONT1 for controlling an operation of the gate driver 300 based on the input control signal CONT, and output the first control signal CONT1 to the gate driver 300. The first control signal CONT1 may include a vertical start signal and a gate clock signal.

The driving controller 200 may generate the second control signal CONT2 for controlling an operation of the data driver 500 based on the input control signal CONT, and output the second control signal CONT2 to the data driver 500. The second control signal CONT2 may include a horizontal start signal and a load signal. The driving controller 200 may generate the data signal DATA based on the input image data IMG. The driving controller 200 may output the data signal DATA to the data driver 500.

The driving controller 200 may generate the third control signal CONT3 for controlling an operation of the gamma reference voltage generator 400 based on the input control signal CONT, and output the third control signal CONT3 to the gamma reference voltage generator 400.

The driving controller 200 may generate the fourth control signal CONT4 for controlling an operation of the emission driver 600 based on the input control signal CONT, and output the fourth control signal CONT4 to the emission driver 600.

The gate driver 300 may generate gate signals for driving the gate lines GL in response to the first control signal CONT1 received from the driving controller 200. The gate driver 300 may output the gate signals to the gate lines GL.

According to some embodiments, the gate driver 300 may be integrated on the peripheral area of the display panel 100.

The gamma reference voltage generator 400 may generate a gamma reference voltage VGREF in response to the third control signal CONT3 received from the driving controller 200. The gamma reference voltage generator 400 may provide the gamma reference voltage VGREF to the data driver 500. The gamma reference voltage VGREF may have a value corresponding to each data signal DATA.

According to some embodiments, the gamma reference voltage generator 400 may be arranged in the driving controller 200 or may be arranged in the data driver 500.

The data driver 500 may receive the second control signal CONT2 and the data signal DATA from the driving controller 200, and receive the gamma reference voltage VGREF from the gamma reference voltage generator 400. The data driver 500 may convert the data signal DATA into a data voltage having an analog type using the gamma reference voltage VGREF. The data driver 500 may output the data voltage to the data line DL.

The emission driver 600 may generate emission signals for driving the emission lines EML in response to the fourth control signal CONT4 received from the driving controller 200. The emission driver 600 may output the emission signals to the emission lines EML.

According to some embodiments, the emission driver 600 may be integrated in the peripheral area of the display panel 100. According to some embodiments, the emission driver 600 may be mounted in the peripheral area of the display panel 100.

In FIG. 1, for a convenience of an explanation, the gate driver 300 may be arranged on a first side of the display panel 100 and the emission driver 600 may be arranged on a second side of the display panel 100. Although shown, the present disclosure is not limited thereto. According to some embodiments, both the gate driver 300 and the emission driver 600 may be arranged on the first side of the display panel 100. According to some embodiments, both the gate driver 300 and the emission driver 600 may be arranged on respective sides of the display panel 100. According to some embodiments, the gate driver 300 and the emission driver 600 may be formed integrally.

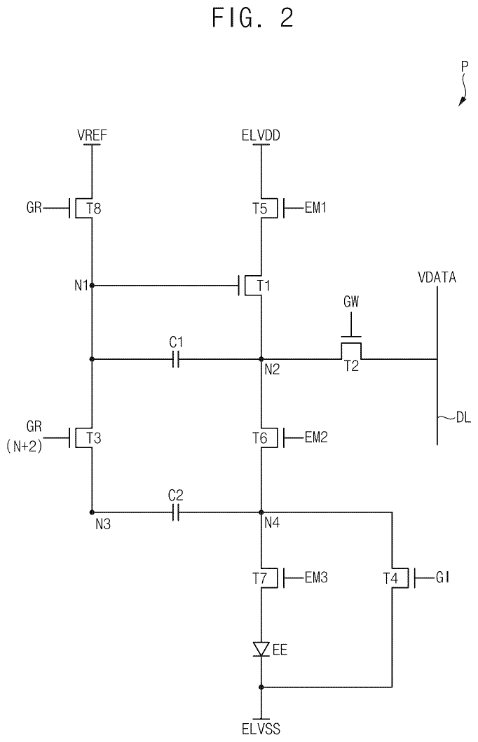

FIG. 2 is a circuit diagram showing an example of a pixel circuit of FIG. 1. Although FIG. 2 illustrates various components in a pixel according to some embodiments, embodiments according to the present disclosure are not limited thereto, and according to various embodiments, the pixel may include additional components or fewer components without departing from the spirit and scope of embodiments according to the present disclosure.

Referring to FIG. 2, a pixel circuit P may include a first transistor T1, a second transistor T2, a third transistor T3, a first capacitor C1, a second capacitor C2, and a light emitting element EE.

The first transistor T1 may generate a driving current based on a voltage between a first node N1 and a second node N2. According to some embodiments, the first transistor T1 may include a control electrode connected to a first node N1 and a first electrode connected to a line of a high power supply voltage ELVDD, and may further include a second electrode connected to the second node N2. According to some embodiments, the high power supply voltage ELVDD may be 13 V.

The second transistor T2 may provide a data voltage VDATA to the second node N2 in response to a data write gate signal GW. According to some embodiments, the second transistor T2 may include a control electrode receiving the data write gate signal GW, a first electrode connected to a data line DL providing the data voltage VDATA, and a second electrode connected to the second node N2.

The third transistor T3 may selectively connect the first node N1 and a third node N3 in response to a reset gate signal GR (N+2) of a next stage. According to some embodiments, the third transistor T3 may include a control electrode receiving the reset gate signal GR (N+2) of the next stage, a first electrode connected to the first node N1, and a second electrode connected to the third node N3.

The first capacitor C1 may store the data voltage VDATA. According to some embodiments, the first capacitor C1 may include a first electrode connected to the second node N2 and a second electrode connected to the first node N1. For example, according to some embodiments, the first electrode of the first capacitor C1 may be connected between the first transistor T1 and the second transistor T2, and the second electrode of the first capacitor C1 may be connected to the third transistor T3.

The second capacitor C2 may extend a data range of the data voltage VDATA. According to some embodiments, the second capacitor C2 may include a first electrode connected to the third node N3 and a second electrode connected to a fourth node N4.

The light emitting element EE may emit a light based on the driving current. According to some embodiments, the light emitting element EE may include an anode connected to the fourth node N4 and a cathode connected to a line of a low power supply voltage ELVSS. According to some embodiments, the low power supply voltage ELVSS may be 1 V.

The pixel circuit P may further include a fourth transistor T4. The fourth transistor T4 may provide the low power supply voltage ELVSS to the fourth node N4 in response to an initialization gate signal GI. According to some embodiments, the fourth transistor T4 may include a control electrode receiving the initialization gate signal GI, a first electrode connected to the line of the low power supply voltage ELVSS, and a second electrode connected to the fourth node N4.

The pixel circuit P may further include a fifth transistor T5. The fifth transistor T5 may selectively connect the line of the high power supply voltage ELVDD and the first electrode of the first transistor T1 in response to a first emission signal EM1. According to some embodiments, the fifth transistor T5 may include a control electrode receiving the first emission signal EM1, a first electrode connected to the line of the high power supply voltage ELVDD, and a second electrode connected to the first electrode of the first transistor T1.

The pixel circuit P may further include a sixth transistor T6 and a seventh transistor T7. The sixth transistor T6 may selectively connect the second node N2 and the fourth node N4 in response to the second emission signal EM2. According to some embodiments, the sixth transistor T6 may include a control electrode receiving the second emission signal EM2, a first electrode connected to the second node N2, and a second electrode connected to the fourth node N4.

The seventh transistor T7 may selectively connect the fourth node N4 and the anode of the light emitting element EE in response to a third emission signal EM3. According to some embodiments, the seventh transistor T7 may include a control electrode receiving the third emission signal EM3, a first electrode connected to the fourth node N4, and an output electrode connected to the anode of the light emitting element EE.

The fifth transistor T5, the sixth transistor T6, and the seventh transistor T7 may form a path of the driving current from the line of the high power supply voltage ELVDD to the line of the low power supply voltage ELVSS together with the first transistor T1.

The eighth transistor T8 may provide the reference voltage VREF to the first node N1 in response to a reset gate signal GR. According to some embodiments, the eighth transistor T8 may include a control electrode receiving the reset gate signal GR, a first electrode connected to a line of the reference voltage VREF, and a second electrode connected to the first node N1. According to some embodiments, the reference voltage VREF may be 2 V.

In FIG. 2, GR (N+2) means the reset gate signal of the next stage, and GR means a reset gate signal of a current stage. That is, GR may be equal to GR (N). In the case of other gate signals GW, GI, the other gate signals GW, GI may also mean gate signals of the current stage. In addition, in the case of emission signals EM1, EM2, EM3, the emission signals EM1, EM2, EM3 may also mean emission signals of the current stage.

The data write gate signal GW, the reset gate signal GR, the reset gate signal of the next stage GR (N+2), the initialization gate signal GI, the first emission signal EM1, the second emission signal EM2, and the third emission signal EM3 may have a high level and a low level. According to some embodiments, the high level may be 14 V, and the low level may be −7 V.

According to some embodiments, the first to eighth transistors T1 to T8 may be N-type transistors. According to some embodiments, when a signal applied to a control electrode of an N-type transistor has the high level, the N-type transistor may be turned on. According to some embodiments, when the signal applied to the control electrode of the N-type transistor has the low level, the N-type transistor may be turned off.

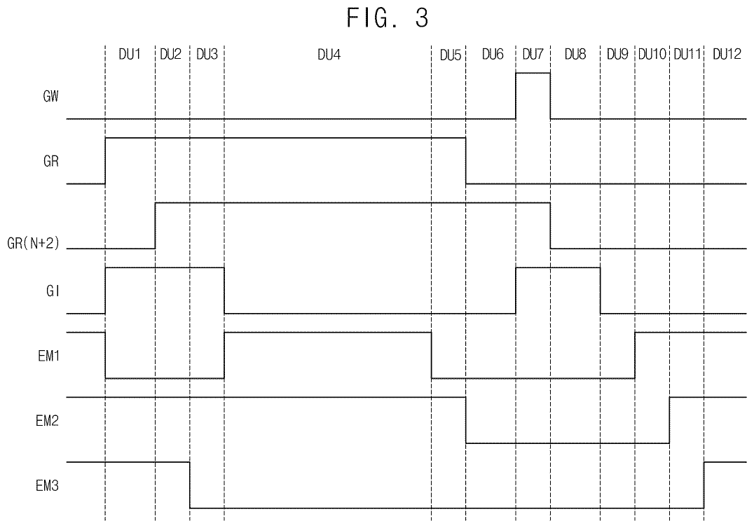

FIG. 3 is a timing diagram showing an example of an operation of a pixel circuit of FIG. 2.

Referring to FIGS. 2 and 3, each frame period for the pixel circuit P may include first to twelfth durations DU1 to DU12.

In the first duration DU1, the reset gate signal GR, the initialization gate signal GI, the second emission signal EM2, and the third emission signal EM3 may have the high level, and the data write gate signal GW, the reset gate signal GR (N+2) of the next stage, and the first emission signal EM1 may have the low level.

In the second duration DU2 following the first duration DU1, the reset gate signal GR, the reset gate signal GR (N+2) of the next stage, the initialization gate signal GI, the second emission signal EM2, and the third emission signal EM3 may have the high level, and the data write gate signal GW and the first emission signal EM1 may have the low level.

In the third duration DU3 following the second duration DU2, the reset gate signal GR, the reset gate signal GR (N+2) of the next stage, the initialization gate signal GI, and the second emission signal EM2 may have the high level, and the data write gate signal GW, the first emission signal, and the third emission signal EM3 may have the low level.

In the fourth duration DU4 following the third duration DU3, the reset gate signal GR, the reset gate signal GR (N+2) of the next stage, the first emission signal EM1, and the second emission signal EM2 may have the high level, and the data write gate signal GW, the initialization gate signal GI, and the third emission signal EM3 may have the low level.

In the fifth duration DU5 following the fourth duration DU4, the reset gate signal GR, the reset gate signal GR (N+2) of the next stage, and the second emission signal EM2 may have the high level, and the data write gate signal GW, the initialization gate signal GI, the first emission signal EM1, and the third emission signal EM3 may have the low level.

In the sixth duration DU6 following the fifth duration DU5, the reset gate signal GR (N+2) of the next stage may have the high level, and the data write gate signal GW, the reset gate signal GR, the initialization gate signal GI, the first emission signal EM1, the second emission signal EM2, and the third emission signal EM3 may have the low level.

In the seventh duration DU7 following the sixth duration DU6, the data write gate signal GW, the reset gate signal GR (N+2) of the next stage, and the initialization gate signal GI may have the high level, and the reset gate signal GR, the first emission signal EM1, the second emission signal EM2, and the third emission signal EM3 may have the low level. According to some embodiments, a duration DU7 in which the data write gate signal GW has the high level may be less than or equal to one horizontal period.

In the eighth duration DU8 following the seventh duration DU7, the initialization gate signal GI may have the high level, and the data write gate signal GW, the reset gate signal GR, the reset gate signal GR (N+2) of the next stage, the first emission signal EM1, the second emission signal EM2, and the third emission signal EM3 may have the low level.

In the ninth duration DU9 following the eighth duration DU8, the data write gate signal GW, the reset gate signal GR, the reset gate signal GR (N+2) of the next stage, the initialization gate signal GI, the first emission signal EM1, the second emission signal EM2, and the third emission signal EM3 may have the low level.

In the tenth duration DU10 following the ninth duration DU9, the first emission signal EM1 may have the high level, and the data write gate signal GW, the reset gate signal GR, the reset gate signal GR (N+2) of the next stage, the initialization gate signal GI, the second emission signal EM2, and the third emission signal EM3 may have the low level.

In the eleventh duration DU11 following the tenth duration DU10, the first emission signal EM1 and the second emission signal EM2 may have the high level, and the data write gate signal GW, the reset gate signal GR, the reset gate signal GR (N+2) of the next stage, the initialization gate signal GI, and the third emission signal EM3 may have the low level.

In the twelfth duration DU12 following the eleventh duration DU11, the first emission signal EM1, the second emission signal EM2, and the third emission signal EM3 may have the high level, and the data write gate signal GW, the reset gate signal GR, the reset gate signal GR (N+2) of the next stage, and the initialization gate signal GI may have the low level.

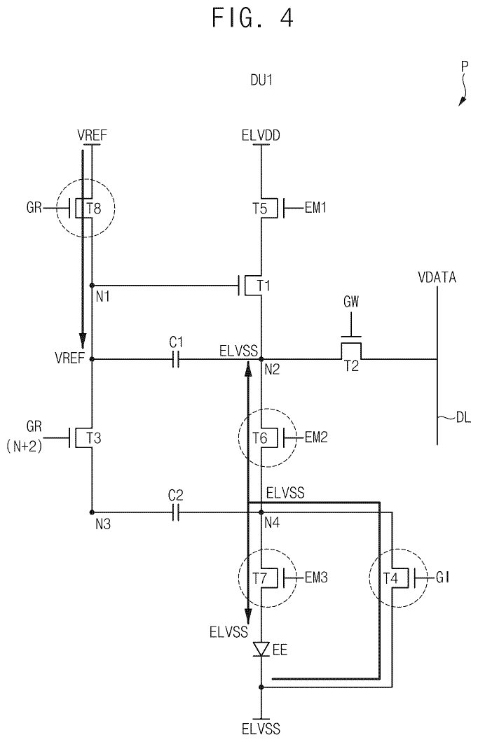

FIG. 4 is a circuit diagram showing an example in which a pixel circuit of FIG. 2 operates in a first duration.

Referring to FIGS. 2 to 4, in the first duration DU1, the fourth transistor T4 may be turned on in response to the initialization gate signal GI having the high level to provide the low power voltage ELVSS to the fourth node N4. The sixth transistor T6 may be turned on in response to the second emission signal EM2 having the high level to provide the voltage of the fourth node N4 to the second node N2. The seventh transistor T7 may be turned on in response to the third emission signal EM3 having the high level to provide a voltage of the fourth node N4 to the anode of the light emitting element EE. Therefore, the fourth node N4, the second node N2, and the anode of the light emitting element EE may be initialized to the low power voltage ELVSS.

The eighth transistor T8 may be turned on in response to the reset gate signal GR having the high level to provide the reference voltage VREF to the first node N1. Therefore, the first node N1 may be initialized to the reference voltage VREF.

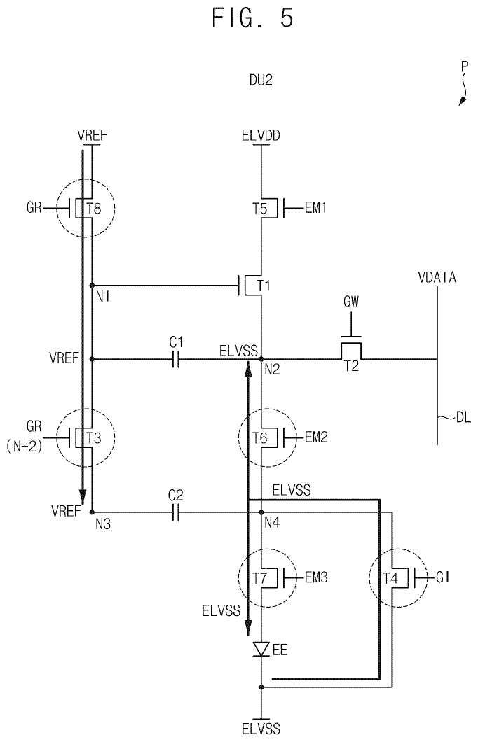

FIG. 5 is a circuit diagram showing an example in which a pixel circuit of FIG. 2 operates in a second duration.

Referring to FIGS. 2 to 5, in the second duration DU2, the fourth transistor T4, the sixth transistor T6, the seventh transistor T7, and the eighth transistor T8 may maintain a turn-on state, such that the voltage of the fourth node N4, a voltage of the second node N2, and a voltage of the anode of the light emitting element EE may be maintained at the low power voltage ELVSS, and the voltage of the first node N1 may be maintained at the reference voltage VREF.

The third transistor T3 may be turned on in response to the reset gate signal GR (N+2) of the next stage having the high level to provide the voltage of the first node N1 to the third node N3. Therefore, the third node N3 may be initialized to the reference voltage VREF.

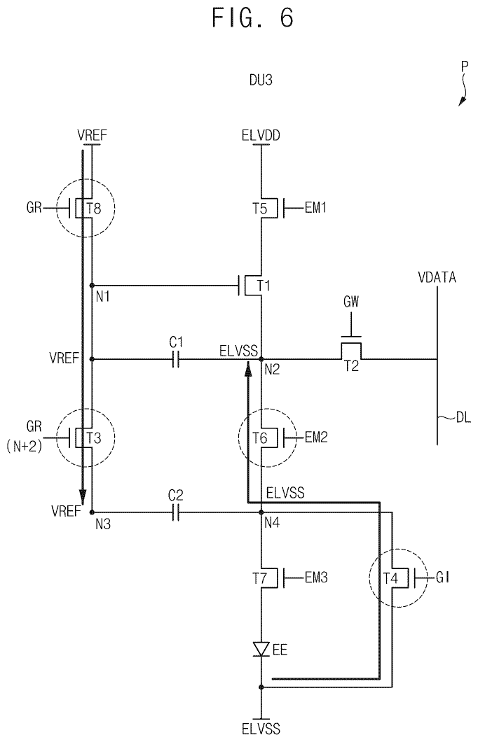

FIG. 6 is a circuit diagram showing an example in which a pixel circuit of FIG. 2 operates in a third duration.

Referring to FIGS. 2 to 6, in the third duration DU3, the fourth transistor T4, the sixth transistor T6, the eighth transistor T8, and the third transistor T3 may maintain the turn-on state, such that the voltage of the fourth node N4 and the voltage of the second node N2 may be maintained at the low power supply voltage ELVSS, and the voltage of the first node N1 and the voltage of the third node N3 may be maintained at the reference voltage VREF.

The seventh transistor T7 may be turned off in response to the third emission signal EM3 having the low level, such that the seventh transistor T7 may not provide the voltage of the fourth node N4 to the anode of the light emitting element EE.

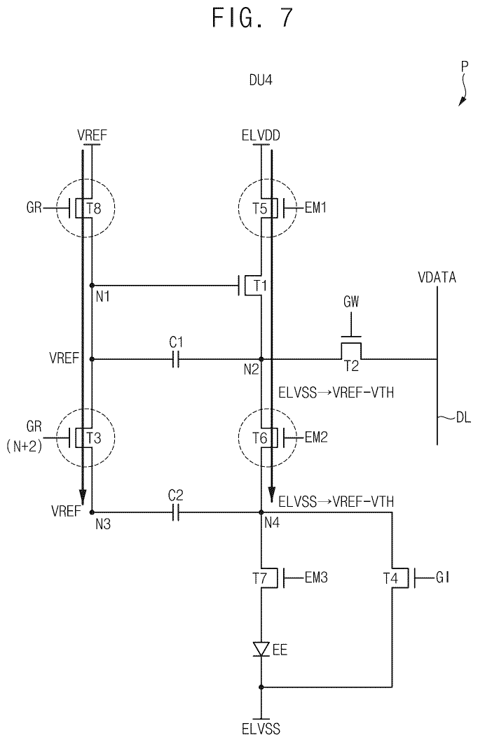

FIG. 7 is a circuit diagram showing an example in which a pixel circuit of FIG. 2 operates in a fourth duration.

Referring to FIGS. 2 to 7, in the fourth duration DU4, the eighth transistor T8 and the third transistor T3 may maintain the turn-on state, such that the voltage of the first node N1 and the voltage of the third node N3 may be maintained at the reference voltage VREF.

When the voltage of the first node N1 is the reference voltage VREF and the fifth transistor T5 is turned on, the first transistor T1 may be turned on with an on-condition. In addition, the first transistor T1 may be turned on until the voltage of the second node N2 becomes a voltage “VREF−VTH”, which is obtained by subtracting a threshold voltage VTH of the first transistor T1 from the reference voltage VREF, from the low power supply voltage ELVSS. In addition, the fourth transistor T4 may be turned off in response to the initialization gate signal GI having the low level, such that the fourth transistor T4 may not provide the low power supply voltage ELVSS to the fourth node N4. Therefore, the voltage of the second node N2 may be changed from the low power supply voltage ELVSS to the reference voltage minus threshold voltage “VREF−VTH”. Because a voltage of the first electrode of the first capacitor C1 is the reference voltage minus threshold voltage “VREF−VTH” and a voltage of the second electrode of the first capacitor C1 is the reference voltage VREF, the first capacitor C1 may store the threshold voltage VTH of the first transistor T1 between the two electrodes. Therefore, the threshold voltage VTH of the first transistor T1 may be compensated.

The sixth transistor T6 may maintain the turn-on state and provide the voltage of the second node N2 to the fourth node N4. Therefore, the voltage of the fourth node N4 may be changed from the low power supply voltage ELVSS to the reference voltage minus threshold voltage “VREF−VTH”. Because a voltage of the second electrode of the second capacitor C2 is the reference voltage minus threshold voltage “VREF−VTH” and a voltage of the first electrode of the second capacitor C2 is the reference voltage VREF, the second capacitor C2 may store the threshold voltage VTH of the first transistor T1 between the two electrodes.

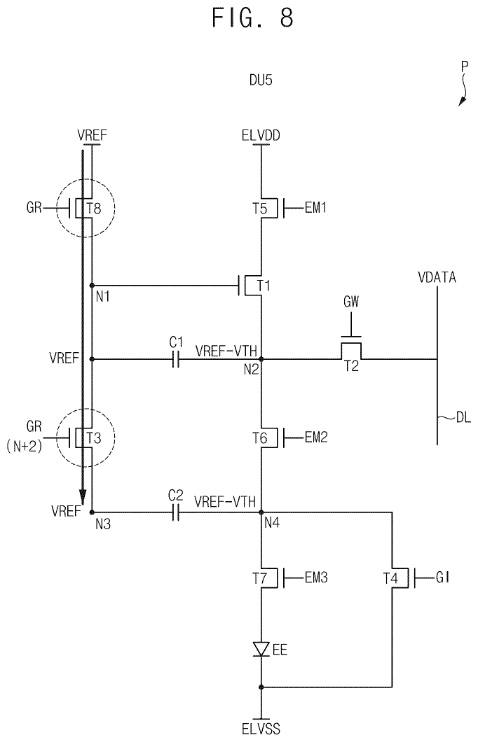

FIG. 8 is a circuit diagram showing an example in which a pixel circuit of FIG. 2 operates in a fifth duration.

Referring to FIGS. 2 to 8, in the fifth duration DU5, the eighth transistor T8 and the third transistor T3 may maintain the turn-on state, such that the voltage of the first node N1 and the voltage of the third node N3 may be maintained at the reference voltage VREF.

The fifth transistor T5 may be turned off in response to the first emission signal EM1 having the low level, such that the fifth transistor T5 may not provide the low power voltage ELVDD to the first electrode of the first transistor T1. The sixth transistor T6 may maintain the turn-on state to connect the second node N2 and the fourth node N4, such that the voltage of the second node N2 and the voltage of the fourth node N4 may be maintained at the reference voltage minus threshold voltage “VREF−VTH”.

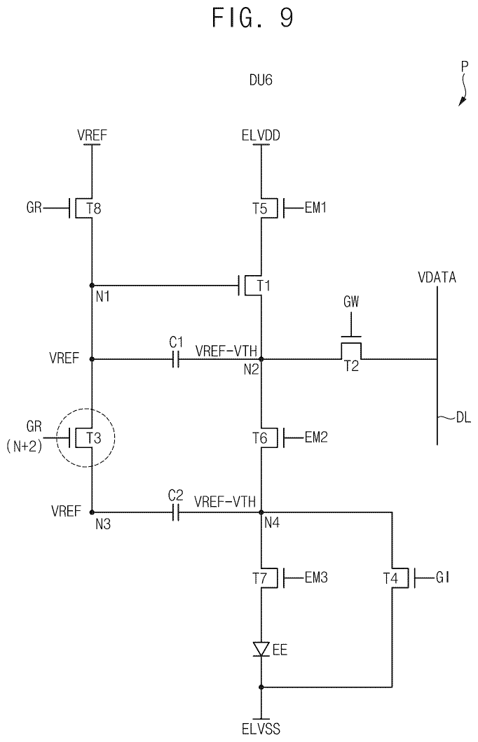

FIG. 9 is a circuit diagram showing an example in which a pixel circuit of FIG. 2 operates in a sixth duration.

Referring to FIGS. 2 to 9, in the sixth duration DU6, the eighth transistor T8 may be turned off in response to the reset gate signal GR having the low level, such that the eighth transistor T8 may not provide the reference voltage VREF to the first node N1. The third transistor T3 may maintain the turn-on state, and the voltage of the first node N1 and the voltage of the third node N3 may be maintained at the reference voltage VREF.

The sixth transistor T6 may be turned off in response to the second emission signal EM2 having the low level, such that the sixth transistor T6 may not connect the third node N3 and the fifth node N5. The voltage of the second node N2 and the voltage of the fourth node N4 may be maintained at the reference voltage minus threshold voltage “VREF−VTH”.

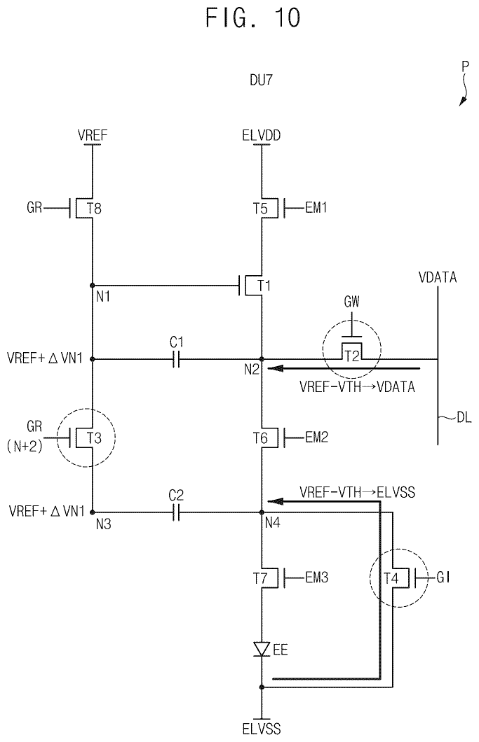

FIG. 10 is a circuit diagram showing an example in which a pixel circuit of FIG. 2 operates in a seventh duration.

Referring to FIGS. 2 to 10, in the seventh duration DU7, the second transistor T2 may be turned on in response to the data write gate signal GW having the high level to provide the data voltage VDATA to the second node N2. Therefore, the voltage of the second node N2 may be changed from the reference voltage minus threshold voltage “VREF−TH” to the data voltage VDATA.

The fourth transistor T4 may be turned on in response to the initialization gate signal GI having the high level to provide the low power voltage ELVSS to the fourth node N4. Therefore, the voltage of the fourth node N4 may be changed from the reference voltage minus threshold voltage “VREF−TH” to the low power supply voltage ELVSS.

The third transistor T3 may maintain the turn-on state to connect the first node N1 and the third node N3, and the voltage of the first node N1 and the voltage of the third node N3 may be maintained identical to each other.

According to some embodiments, when the voltage of the second node N2 changes by “VDATA−(VREF−VTH)” and the voltage of the fourth node N4 changes by “ELVSS−(VREF−VTH)”, the voltage of the first node N1 and the voltage of the third node N3 may be changed based on a voltage distribution of the first capacitor C1 and the second capacitor C2. A voltage change amount ΔVN1 of the first node N1 may be “(C_C1/(C_C1+C_C2))×(VDATA−(VREF−VTH))+(C_C2/(C_C1+C_C2))×(ELVSS−(VREF−VTH))”. The voltage of the first node N1 may be “VREF+ΔVN1”, that is, “VREF+(C_C1/(C_C1+C_C2))×(VDATA−(VREF−VTH))+(C_C2/(C_C1+C_C2))×(ELVSS−(VREF−VTH))”.

When the voltage of the first node N1 is “VREF+(C_C1/(C_C1+C_C2))×(VDATA−(VREF−VTH))+(C_C2/(C_C1+C_C2))×(ELVSS−(VREF−VTH))” and the voltage of the second node N2 is “VDATA”, the gate-source voltage of the first transistor T1 may be “VREF+(C_C1/(C_C1+C_C2))×(VDATA−(VREF−VTH))+(C_C2/(C_C1+C_C2))×(ELVSS−(VREF−VTH))−VDATA”. When the gate-source voltage of the first transistor T1 is divided into a component of VTH, a component of VDATA, and a component of ELVSS, the gate-source voltage of the first transistor T1 may be “VTH+(C_C1/(C_C1+C_C2))×VDATA+(C_C2/(C_C1+C_C2))×ELVSS−VDATA”. Here, C_C1 is a capacitance of the first capacitor C1, and C_C2 is a capacitance of the second capacitor C2.

Because the gate-source voltage of the first transistor T1 is greater than the threshold voltage VTH of the first transistor T1, the first transistor T1 may be turned on with the on-condition.

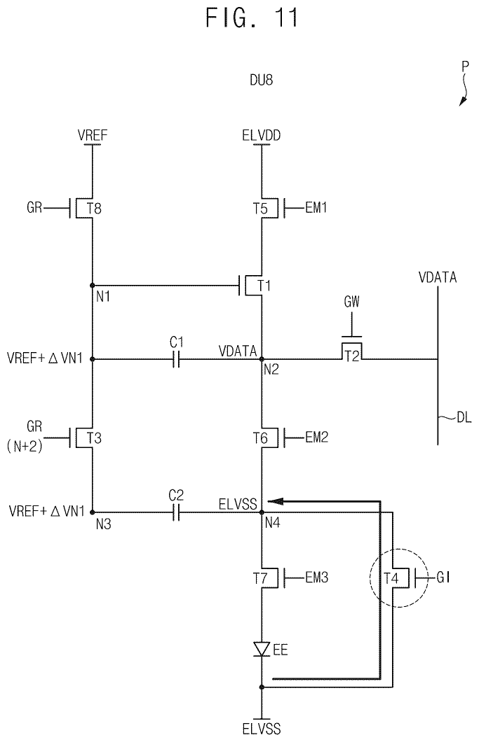

FIG. 11 is a circuit diagram showing an example in which a pixel circuit of FIG. 2 operates in an eighth duration.

Referring to FIGS. 2 to 11, in the eighth duration DU8, the fourth transistor T4 may maintain the turn-on state, such that the voltage of the fourth node N4 may be maintained at the low power supply voltage ELVSS.

The second transistor T2 may be turned off in response to the data write gate signal GW having the low level, such that the second transistor T2 may not provide the data voltage VDATA to the second node N2.

The third transistor T3 may be turned off in response to the reset gate signal GR (N+2) of the next stage having the low level, such that the first node N1 and the third node N3 may not be connected. The voltage of the second node N2 may be maintained at the data voltage VDATA, and the voltage of the first node N1 and the voltage of the third node N3 may be maintained at “VREF+ΔVN1”, that is, “VTH+ (C_C1/(C_C1+C_C2))×VDATA+(C_C2/(C_C1+C_C2))×ELVSS”.

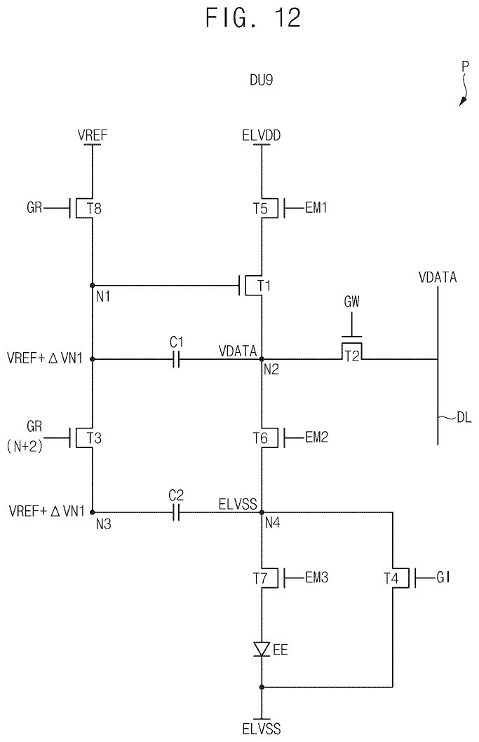

FIG. 12 is a circuit diagram showing an example in which a pixel circuit of FIG. 2 operates in a ninth duration.

Referring to FIGS. 2 to 12, in the ninth duration DU9, the fourth transistor T4 may be turned off in response to the initialization gate signal GI having the low level, such that the ninth duration DU9 may not provide the low power voltage ELVSS to the fourth node N4.

The voltage of the second node N2 may be maintained at the data voltage VDATA, the voltage of the first node N1 and the voltage of the third node N3 may be maintained at “VREF+ΔVN1”, that is, “VTH+(C_C1/(C_C1+C_C2))×VDATA+ (C_C2/(C_C1+C_C2))×ELVSS”, and the voltage of the fourth node N4 may be maintained at the low power voltage ELVSS.

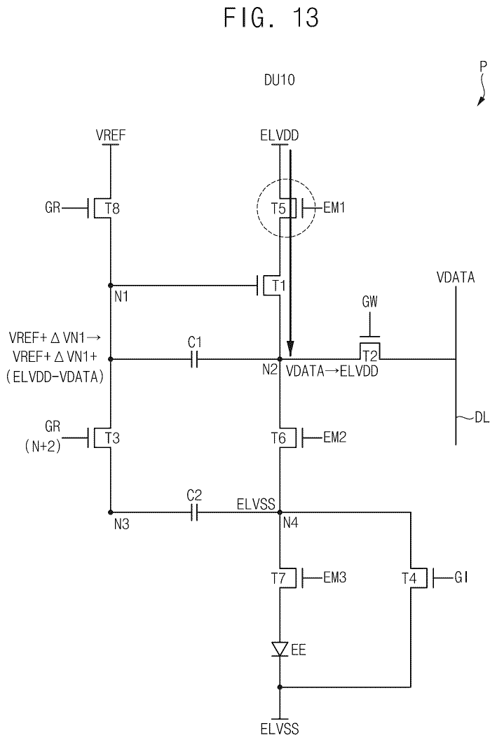

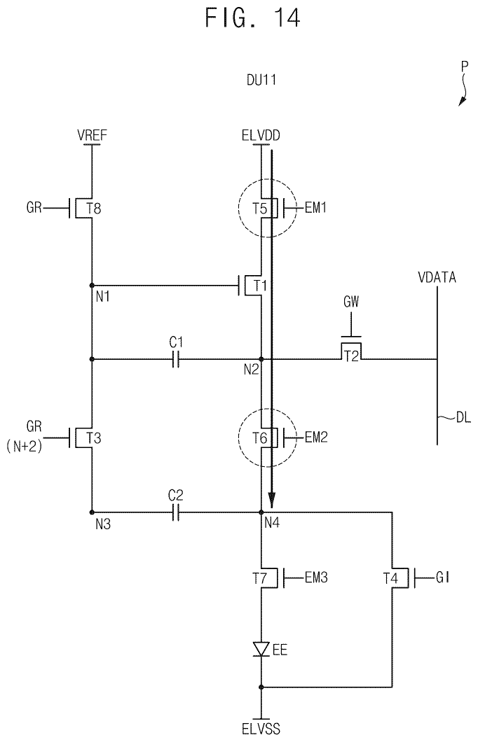

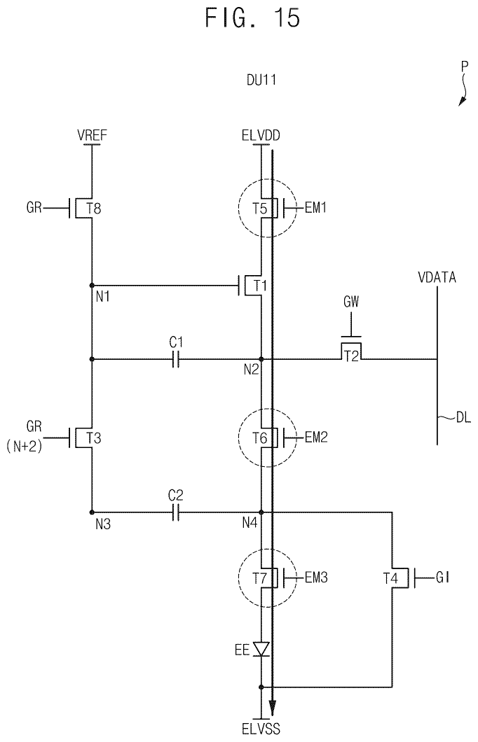

FIG. 13 is a circuit diagram showing an example in which a pixel circuit of FIG. 2 operates in a tenth duration. FIG. 14 is a circuit diagram showing an example in which a pixel circuit of FIG. 2 operates in an eleventh duration. FIG. 15 is a circuit diagram showing an example in which a pixel circuit of FIG. 2 operates in a twelfth duration.

Referring to FIGS. 2 to 15, in the tenth duration DU10, the fifth transistor T5 may be turned on in response to the first emission signal EM1 having the high level, and the first transistor T1 may maintain the turn-on state. The fifth transistor T5 and the first transistor T1 may provide the high power supply voltage ELVDD to the second node N2. Therefore, the voltage of the second node N2 may be changed from the data voltage VDATA to the high power supply voltage ELVDD by “ELVDD−VDATA”.

When the voltage of the second node N2 is changed, the voltage of the first node N1 may be changed while a voltage stored between the two electrodes of the first capacitor C1 is maintained. Therefore, the voltage of the first node N1 may be changed from “VREF+ΔVN1” to “VREF+ΔVN1+(ELVDD−VDATA)” by “ELVDD−VDATA”.

When the voltage of the first node N1 is “VREF+ΔVN1+(ELVDD−VDATA)” and the voltage of the second node N2 is “ELVDD”, the gate-source voltage of the first transistor T1 may be “VREF+ΔVN1−VDATA”, that is, “VTH+ (C_C1/(C_C1+C_C2))×VDATA+(C_C2/(C_C1+C_C2))×ELVSS−VDATA”. Because the gate-source voltage of the first transistor T1 includes the threshold voltage VTH of the first transistor T1, and the driving current is determined based on a voltage obtained by subtracting the threshold voltage VTH of the first transistor T1 from the gate-source voltage of the first transistor T1, the driving current may be determined independently of the threshold voltage VTH of the first transistor T1. In addition, because “C1/(C1+C2)” is less than 1, the data range of the data voltage VDATA may be relatively expanded.

In the eleventh duration DU11, the fifth transistor T5 and the first transistor T1 may maintain the turn-on state, and the sixth transistor T6 may be turned on in response to the second emission signal EM2 having the high level. In the twelfth duration DU12, the fifth transistor T5, the first transistor T1, and the sixth transistor T6 may maintain the turn-on state, and the seventh transistor T7 may be turned on in response to the third emission signal EM3 having the high level. Therefore, the path of the driving current from the line of the high power supply voltage ELVDD to the line of the low power supply voltage ELVSS may be formed.

The light emitting element EE may emit a light based on the driving current.

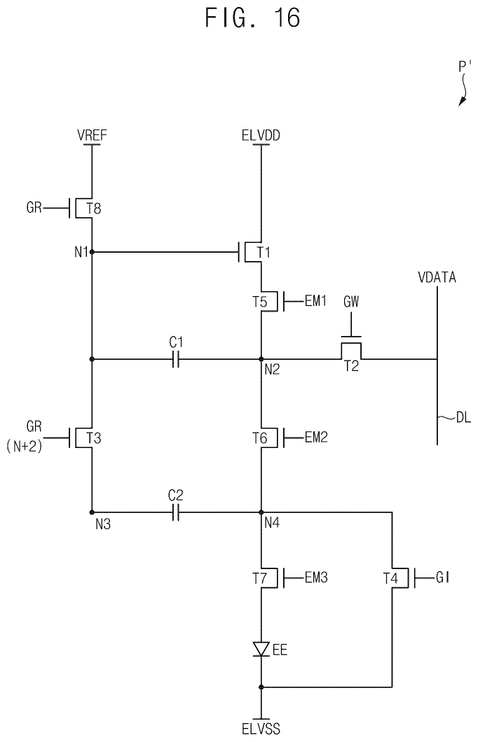

FIG. 16 is a circuit diagram showing an example of a pixel circuit of FIG. 1. Although FIG. 16 illustrates various components in a pixel according to some embodiments, embodiments according to the present disclosure are not limited thereto, and according to various embodiments, the pixel may include additional components or fewer components without departing from the spirit and scope of embodiments according to the present disclosure.

Referring to FIG. 16, a pixel circuit P′ according to some embodiments of the present disclosure may include first to eighth transistors T1 to T8, a first capacitor C1, a second capacitor C2, and a light emitting element EE.

The pixel circuit P′ of FIG. 16 may have a same (or substantially a same) structure and a same operation as the pixel circuit P of FIG. 2, except that the fifth transistor T5 is arranged between the second electrode of the first transistor T1 and the second node N2. Therefore, a duplicate description is omitted.

In the pixel circuit P′ of FIG. 6, the fifth transistor T5 may selectively connect a second electrode of a first transistor T1 and a second node N2 in response to a first emission signal EM1. According to some embodiments, the fifth transistor T5 may include a control electrode receiving the first emission signal EM1, a first electrode connected to the second electrode of the first transistor T1, and a second electrode connected to the second node N2.

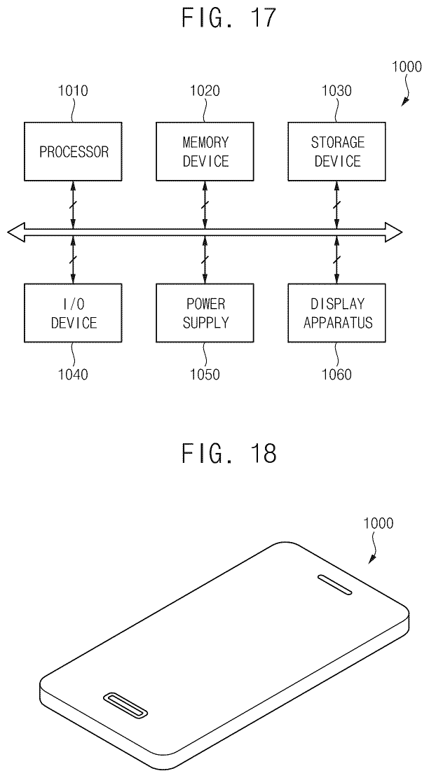

FIG. 17 is a block diagram showing an electronic device. FIG. 18 is a diagram showing aspects of embodiments in which an electronic device of FIG. 17 is implemented as a smart phone.

Referring to FIGS. 17 and 18, an electronic device 1000 may include a processor 1010, a memory device 1020, a storage device 1030, an input/output I/O device 1040, a power supply 1050, and a display device 1060. The display device 1060 may be the display device 10 of FIG. 1. In addition, the electronic device 1000 may further include a plurality of ports for communicating with a video card, a sound card, a memory card, a universal serial bus USB device, other electronic device, and the like.

According to some embodiments, as illustrated in FIG. 18, the electronic device 1000 may be implemented as the smart phone. However, the electronic device 1000 is not limited thereto. According to some embodiments, the electronic device 1000 may be implemented as a cellular phone, a video phone, a smart pad, a smart watch, a tablet PC, a car navigation system, a computer monitor, a laptop, a head mounted display HMD device, and the like.

The processor 1010 may perform various computing functions. The processor 1010 may be a micro processor, a central processing unit CPU, an application processor AP, and the like. The processor 1010 may be coupled to other components via an address bus, a control bus, a data bus, and the like. Further, the processor 1010 may be coupled to an extended bus such as a peripheral component interconnection PCI bus.

The memory device 1020 may store data for operations of the electronic device 1000. According to some embodiments, the memory device 1020 may include at least one nonvolatile memory device such as an erasable programmable read-only memory EPROM device, an electrically erasable programmable read-only memory EEPROM device, a flash memory device, a phase change random access memory PRAM device, a resistance random access memory RRAM device, a nano floating gate memory NFGM device, a polymer random access memory PoRAM device, a magnetic random access memory MRAM device, a ferroelectric random access memory FRAM device, and the like and/or at least one volatile memory device such as a dynamic random access memory DRAM device, a static random access memory SRAM device, a mobile DRAM device, and the like.

The storage device 1030 may include a solid state drive SSD device, a hard disk drive HDD device, a CD-ROM device, and the like.

The I/O device 1040 may include an input device such as a keyboard, a keypad, a mouse device, a touch-pad, a touch-screen, and the like, and an output device such as a printer, a speaker, and the like. In some embodiments, the I/O device 1040 may include the display device 1060.

The power supply 1050 may provide power for operations of the electronic device 1000.

The display device 1060 may be connected to other components through buses or other communication links.

Embodiments according to the present disclosure may be applied to any display device and any electronic device including the touch panel. According to some embodiments, embodiments according to the present disclosure may be applied to a mobile phone, a smart phone, a tablet computer, a digital television TV, a 3D TV, a personal computer PC, a home appliance, a laptop computer, a personal digital assistant PDA, a portable multimedia player PMP, a digital camera, a music player, a portable game console, a navigation device, etc.

The foregoing is illustrative of aspects of some embodiments of the present disclosure and are not to be construed as limiting thereof. Although aspects of some embodiments of the present disclosure have been described, those skilled in the art will readily appreciate that many modifications are possible in the embodiments without materially departing from the novel teachings and characteristics of embodiments according to the present disclosure. Accordingly, all such modifications are intended to be included within the scope of embodiments according to the present disclosure as defined in the appended claims, and their equivalents. In the claims, means-plus-function clauses are intended to cover the structures described herein as performing the recited function and not only structural equivalents but also equivalent structures. Therefore, it is to be understood that the foregoing is illustrative of aspects of embodiments according to the present disclosure and is not to be construed as limited to the specific embodiments disclosed, and that modifications to the disclosed embodiments, as well as other embodiments, are intended to be included within the scope of the appended claims. Aspects of embodiments according to the present disclosure are defined by the following claims, with equivalents of the claims to be included therein.

What is claimed is:

1. A pixel circuit, comprising:
a first transistor including a control electrode connected to a first node, a first electrode connected to a line of a high power supply voltage, and a second electrode connected to a second node;
a second transistor including a control electrode configured to receive a data write gate signal, a first electrode connected to a data line configured to provide a data voltage, and a second electrode connected to the second node;
a third transistor including a control electrode configured to receive a reset gate signal of a next stage, a first electrode connected to the first node, and a second electrode connected to a third node;
a first capacitor including a first electrode connected to the second node and a first electrode connected to the first node;
a second capacitor including a first electrode connected to the third node and a second electrode connected to a fourth node; and
a light emitting element including an anode connected to the fourth node and a cathode connected to a line of a low power supply voltage.

2. The pixel circuit of claim 1, further comprising:
a fourth transistor including a control electrode configured to receive an initialization gate signal, a first electrode connected to the line of the low power supply voltage, and a second electrode connected to the fourth node.

3. The pixel circuit of claim 2, further comprising:
a fifth transistor configured to selectively connect the line of the high power supply voltage and the first electrode of the first transistor based on a first emission signal.

4. The pixel circuit of claim 2, further comprising:
a fifth transistor configured to selectively connect the second electrode of the first transistor and the second node based on a first emission signal.

5. The pixel circuit of claim 3, further comprising:
a sixth transistor configured to selectively connect the second node and the fourth node based on a second emission signal; and
a seventh transistor configured to selectively connect the fourth node and the anode of the light emitting element based on a third emission signal.

6. The pixel circuit of claim 5, further comprising:
an eighth transistor including a control electrode configured to receive a reset gate signal, a first electrode connected to a line of a reference voltage, and a second electrode connected to the first node.

7. The pixel circuit of claim 6, wherein the first to eighth transistors are N-type transistors.

8. The pixel circuit of claim 6, wherein, in a first duration,
the reset gate signal, the initialization gate signal, the second emission signal, and the third emission signal have a high level, the data write gate signal, the reset gate signal of the next stage, and the first emission signal have a low level,
the fourth transistor is configured to be turned on in response to the initialization gate signal having the high level to provide the low power supply voltage to the fourth node,
the sixth transistor is configured to be turned on in response to the second emission signal having the high level to provide a voltage of the fourth node to the second node, and
the eighth transistor is configured to be turned on in response to the reset gate signal having the high level to provide the reference voltage to the first node.

9. The pixel circuit of claim 8, wherein, in a second duration following the first duration,
the reset gate signal, the reset gate signal of the next stage, the initialization gate signal, the second emission signal, and the third emission signal have the high level, the data write gate signal and the first emission signal have the low level,
the fourth transistor is configured to be turned on in response to the initialization gate signal having the high level to provide the low power supply voltage to the fourth node,
the sixth transistor is configured to be turned on in response to the second emission signal having the high level to provide the voltage of the fourth node to the second node,
the seventh transistor is configured to be turned on in response to the third emission signal having the high level to provide the voltage of the fourth node to the anode of the light emitting element,
the eighth transistor is configured to be turned on in response to the reset gate signal having the high level to provide the reference voltage to the first node, and
the third transistor is configured to be turned on in response to the reset gate signal of the next stage having the high level to provide a voltage of the first node to the third node.

10. The pixel circuit of claim 9, wherein, in a third duration following the second duration,
the reset gate signal, the reset gate signal of the next stage, the initialization gate signal, and the second emission signal have the high level, the data write gate signal, the first emission signal, and the third emission signal have the low level,
the fourth transistor is configured to be turned on in response to the initialization gate signal having the high level to provide the low power supply voltage to the fourth node,
the sixth transistor is configured to be turned on in response to the second emission signal having the high level to provide the voltage of the fourth node to the second node,
the eighth transistor is configured to be turned on in response to the reset gate signal having the high level to provide the reference voltage to the first node, and
the third transistor is configured to be turned on in response to the reset gate signal of the next stage having the high level to provide the voltage of the first node to the third node.

11. The pixel circuit of claim 10, wherein, in a fourth duration following the third duration,
the reset gate signal, the reset gate signal of the next stage, the first emission signal, and the second emission signal have the high level, the data write gate signal, the initialization gate signal, and the third emission signal have the low level,
the eighth transistor is configured to be turned on in response to the reset gate signal having the high level to provide the reference voltage to the first node,
the third transistor is configured to be turned on in response to the reset gate signal of the next stage having the high level to provide the voltage of the first node to the third node,
the fifth transistor is configured to be turned on in response to the first emission signal having the high level to provide the high power supply voltage to the first electrode of the first transistor, and
the sixth transistor is configured to be turned on in response to the second emission signal having the high level to provide a voltage of the second node to the fourth node.

12. The pixel circuit of claim 11, wherein, in a fifth duration following the fourth duration,
the reset gate signal, the reset gate signal of the next stage, and the second emission signal have the high level, the data write gate signal, the initialization gate signal, the first emission signal, and the third emission signal have the low level,
the eighth transistor is configured to be turned on in response to the reset gate signal having the high level to provide the reference voltage to the first node,
the third transistor is configured to be turned on in response to the reset gate signal of the next stage having the high level to provide the voltage of the first node to the third node, and
the sixth transistor is configured to be turned on in response to the second emission signal having the high level to connect the second node and the fourth node.

13. The pixel circuit of claim 12, wherein, in a sixth duration following the fifth duration, the reset gate signal of the next stage has the high level, and the data write gate signal, the reset gate signal, the initialization gate signal, the first emission signal, the second emission signal, and the third emission signal have the low level.

14. The pixel circuit of claim 13, wherein, in a seventh duration following the sixth duration,
the data write gate signal, the reset gate signal of the next stage, and the initialization gate signal have the high level, the reset gate signal, the first emission signal, the second emission signal, and the third emission signal have the low level,
the fourth transistor is configured to be turned on in response to the initialization gate signal having the high level to provide the low power supply voltage to the fourth node,
the second transistor is configured to be turned on in response to the data write gate signal having the high level to provide the data voltage to the second node, and
the third transistor is configured to be turned on in response to the reset gate signal having the high level to connect the first node and the third node.

15. The pixel circuit of claim 14, wherein, in an eighth duration following the seventh duration,
the initialization gate signal has the high level, the data write gate signal, the reset gate signal, the reset gate signal of the next stage, the first emission signal, the second emission signal, and the third emission signal have the low level, and
the fourth transistor is configured to be turned on in response to the initialization gate signal having the high level to provide the low power supply voltage to the fourth node.

16. The pixel circuit of claim 15, wherein, in a ninth duration following the eighth duration,
the data write gate signal, the reset gate signal, the reset gate signal of the next stage, the initialization gate signal, the first emission signal, the second emission signal, and the third emission signal have the low level.

17. The pixel circuit of claim 16, wherein, in a tenth duration following the ninth duration,
the first emission signal has the high level, the data write gate signal, the reset gate signal, the reset gate signal of the next stage, the initialization gate signal, the second emission signal, and the third emission signal have the low level,
the fifth transistor is configured to be turned on in response to the first emission signal having the high level to provide the high power supply voltage to the first electrode of the first transistor, and
the first transistor is configured to be turned on based on the data voltage to provide a voltage of the first electrode of the first transistor to the second node.

18. A display device, comprising:
a display panel including a pixel circuit; and
a display panel driver configured to drive the display panel,
wherein the pixel circuit comprises:
a first transistor including a control electrode connected to a first node, a first electrode connected to a line of a high power supply voltage, and a second electrode connected to a second node;
a second transistor including a control electrode configured to receive a data write gate signal, a first electrode connected to a data line providing a data voltage, and a second electrode connected to the second node;
a third transistor including a control electrode configured to receive a reset gate signal of a next stage, a first electrode connected to the first node, and a second electrode connected to a third node;
a first capacitor including a first electrode connected to the second node and a first electrode connected to the first node;
a second capacitor including a first electrode connected to the third node and a second electrode connected to a fourth node; and
a light emitting element including an anode connected to the fourth node and a cathode connected to a line of a low power supply voltage.

19. An electronic device, comprising:
a display panel including a pixel circuit;
a display panel driver configured to drive the display panel; and
a processor configured to control the display panel driver,
wherein the pixel circuit comprises:
a first transistor including a control electrode connected to a first node, a first electrode connected to a line of a high power supply voltage, and a second electrode connected to a second node;
a second transistor including a control electrode configured to receive a data write gate signal, a first electrode connected to a data line providing a data voltage, and a second electrode connected to the second node;
a third transistor including a control electrode configured to receive a reset gate signal of a next stage, a first electrode connected to the first node, and a second electrode connected to a third node;
a first capacitor including a first electrode connected to the second node and a first electrode connected to the first node;
a second capacitor including a first electrode connected to the third node and a second electrode connected to a fourth node; and
a light emitting element including an anode connected to the fourth node and a cathode connected to a line of a low power supply voltage.

20. The electronic device of claim 19, wherein the electronic device is a smart phone.
